(19) United States
(12) Patent Application Publication
(10) Pub. No.: US 2006/0174526 A1
(43) Pub. Date: Aug. 10, 2006

(54) Cover for elongated member and method and apparatus for making same

(76) Inventors: Kent A. Kekeis, St. John, IN (US); John D. Intagliata, Antelope, CA (US); James R. Martin, Estaboga, AL (US)

Correspondence Address: BRINKS HOFER GILSON & LIONE, P.O. BOX 10395, CHICAGO, IL, 60610, US

(21) Appl. No.: 11/348,679

(22) Filed: Feb. 7, 2006

Related U.S. Application Data
(60) Provisional application No. 60/657,874, filed on Mar. 2, 2005.
(60) Provisional application No. 60/651,573, filed on Feb. 10, 2005.

(51) Int. Cl. G09F 7/00

(52) U.S. Cl. 40/612

(57) ABSTRACT

A cover for use on an elongated member includes a strip having a helical configuration, an inner surface and an outer surface. At least a portion of the outer surface includes informational indicia, while the inner surface is adapted to grip the elongated member. The strip has sufficient rigidity such that the strip maintains the helical configuration when the strip is in a freestanding configuration. A method of installing the cover on the elongated member is also provided, along with a method of making one embodiment of the cover. In another aspect, a cover for use on an elongated member includes a longitudinally extending, resilient channel having a tab portion adapted to engage the elongated member. In another aspect, the cover includes a channel and a secondary panel.

This application claims the benefit of U.S. Provisional Application No. 60/657,874, filed Mar. 2, 2005, and U.S. Provisional Application No. 60/651,573, filed Feb. 10, 2005, the entire disclosures of which are hereby incorporated herein by reference.

### FIELD OF INVENTION

The present invention relates to a cover for use on an elongated member, for example a sign post, and in particular, to a cover that is easily installed and removed and provides instructional indicia to a passerby.

### BACKGROUND

Signs, including lane markers, often include a post that elevates the sign or marker for greater visibility by a passerby. Often, however, the signs or markers can be difficult to see, for example at night or in inclement weather. In these conditions, it can be desirable to increase the visibility of the post to advise the passerby of the presence of the sign, marker and/or post.

One solution is to wrap the post with a reflective stripe, as shown for example in U.S. Pat. No. 5,023,607. Such stripes however, typically are not sufficiently rigid such that they have a helical shape before or after the application of the stripe. Rather, the stripes are in the form of a tape, which must be carefully wound around the post. Accordingly, the application of the stripes can be very time consuming. Moreover, over time, the stripes can stretch and sag, thereby diminishing the advisory value of the stripes.

In another solution, shown for example in U.S. Patent Application Publication No. US 2002/0124448A1, a reflective cover member is formed of a pliable panel that is adapted to conform to the signpost or the like. However, the cover member is not otherwise secured to the post, and can be displaced.

### SUMMARY

Briefly stated, in one preferred embodiment described below, a cover for use on an elongated member includes a strip having a helical configuration, an inner surface and an outer surface. At least a portion of the outer surface includes informational indicia, while the inner surface is adapted to grip the elongated member. The strip has sufficient rigidity such that the strip maintains the helical configuration when the strip is in a freestanding configuration.

In another aspect, a method of installing the cover on the elongated member includes wrapping the strip around the elongated member with the inner surface thereof gripping the elongated member.

In one embodiment, the strip defines an application length of the cover relative to the post and the strip defines a slit formed between edges of the strip along the helical configuration. The slit has a width. The method includes adjusting the width of at least a portion of the slit between at least a first and second width and thereby adjusting the application length of the cover relative to the post between at least a first and second application length.

In yet another aspect, a cover for use on a post includes a longitudinally extending, resilient channel having opposite first and second ends, an inner surface and an outer surface. At least a portion of the outer surface includes informational indicia. The inner surface is adapted to grip the post. In one embodiment, the channel includes a tab portion adapted to engage the post.

In another aspect, a panel is connected to a channel. In various embodiments, the panel can be made separately from the channel, or formed integrally therewith, for example as a pair of collars with the panel extending therebetween.

In yet another aspect, an apparatus for making a cover for use on an elongated member includes a jig having an interior, a first open end shaped to receive a tube, an opposite second open end and a slot formed in a portion thereof between the first and second open ends. The slot is open to the interior. A slitting member extends through the slot into the interior.

The various covers, and the methods of installation, provide significant advantages over other post covers. For example, the helically configured cover can be easily installed simply by quickly wrapping the strip around the post, for example by hand and without the need for any tools. The cover adapts to the shape of the post and can be quickly installed on a wide variety of posts having different shapes and sizes. Moreover, the resilient material grips the post without the need for additional fasteners. In addition, the width of the slit can be easily adjusted to vary the overall application length of the cover such that the cover can be used to cover various lengths of post. The installation can be performed quickly and easily without the need for any tools.

With respect to the cover having a channel configuration, the tab member can be quickly engaged with the post, again without any tools, thereby allowing for a quick and easy installation of the cover. The tab member maintains the vertical and rotational location of the cover relative to the post.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is a perspective view of a plurality of covers applied to a plurality of posts along a roadway.

FIG. 2 is an enlarged partial view of a first embodiment of a cover applied to a post.

FIG. 3 is a front perspective view of a second embodiment of a cover applied to a post.

FIG. 4 is a front view of a plurality of various embodiments of cover members with various instructional indicia applied thereto.

FIG. 5 is a front view of a plurality of various embodiments of cover members with various instructional indicia applied thereto.

FIG. 6 is a perspective view of a slitting apparatus used to form one embodiment of the cover disclosed herein.

FIG. 7 is a perspective view of an end portion of one embodiment of a cover.

FIG. 8 is another embodiment of a cover.

FIG. 9 is perspective view of another embodiment of a cover with indicia applied thereto.

FIG. 10 is another perspective view of the cover shown in FIG. 9 without indicia.

FIG. 11 is a side view of the cover shown in FIG. 9.

FIG. 12 is a perspective view of another embodiment of a slitting apparatus.

FIG. 13 is a top view of the slitting apparatus shown in FIG. 12.

FIG. 14 is a perspective view of the opposite side of the slitting apparatus shown in FIG. 12.

FIG. 15 is an exploded perspective view of a drive shaft, cutter and blade pressure bar.

### DETAILED DESCRIPTION OF THE PRESENTLY PREFERRED EMBODIMENTS

Referring to FIGS. 1, 3 and 5, a cover 2 includes a strip 8 having an inner surface 4 and an outer surface 6. The strip has opposite side edges 10, 12. The strip is formed in a helical configuration, with the opposite side edges 10, 12 defined by a slit 14 formed therebetween. In one embodiment, the strip is about 5 inches wide, and preferably has a width of between about 3 inches and about 6 inches.

The strip 8 is preferably made of a resilient, flexible material, such as a plastic. In various embodiments, the strip can be made for example and without limitation from a durable linear low density co-extruded polyethylene with UV inhibitors, a urethane/polyurethane material, thermoplastic materials, elastomeric materials, rubber, and/or various combinations thereof. In other embodiments, the strip is made of metal, such as spring steel, aluminum, etc. In one embodiment, the strip is formed by making a helical or spiral cut in one of a Dura-Post® delineator, a RubberTough® delineator, or a Safe-Hit® delineator, all of which are available from the Safe-Hit® line of products offered by Energy Absorption Systems, Inc., the assignee of the present application.

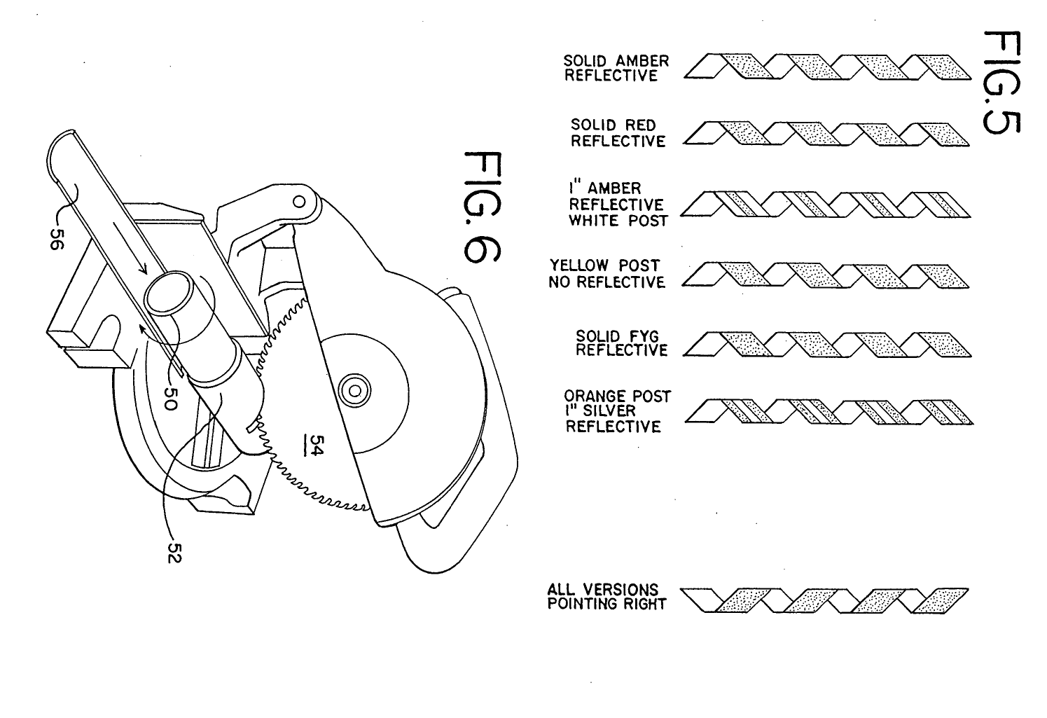

For example, as shown in FIG. 6, a cylindrical tube 50 can be rotated and simultaneously moved/translated longitudinally along its length while cutting the tube at an angle (e.g., with a miter saw) to form the helical slit. A guide, configured as a trough 56, supports the tube 50 on a support surface. The tube is inserted into a jig/fixture 56 having a slot formed in a top thereof, first and second ends and an interior. The slot is formed at an oblique angle (e.g., 22 degrees) to a longitudinal axis of the jig, which corresponds to the longitudinal axis of the tube being slit, and communicates with the interior of the jig.

During manufacture, the operator rotates and translates a tube, preferably configured with a reflective coating, through the jig while penetrating the slot and tube with a slitting member, such as a rotary saw blade.

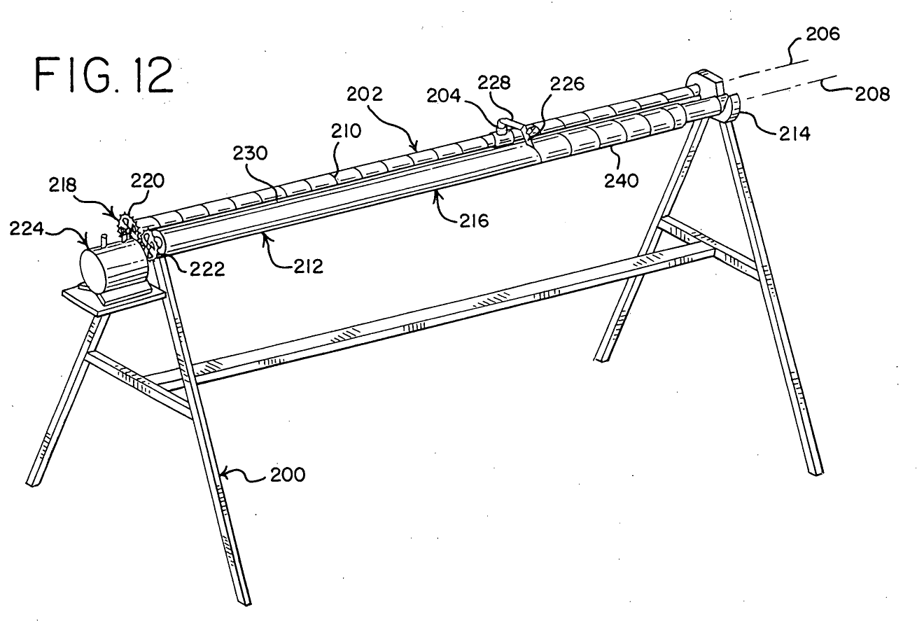

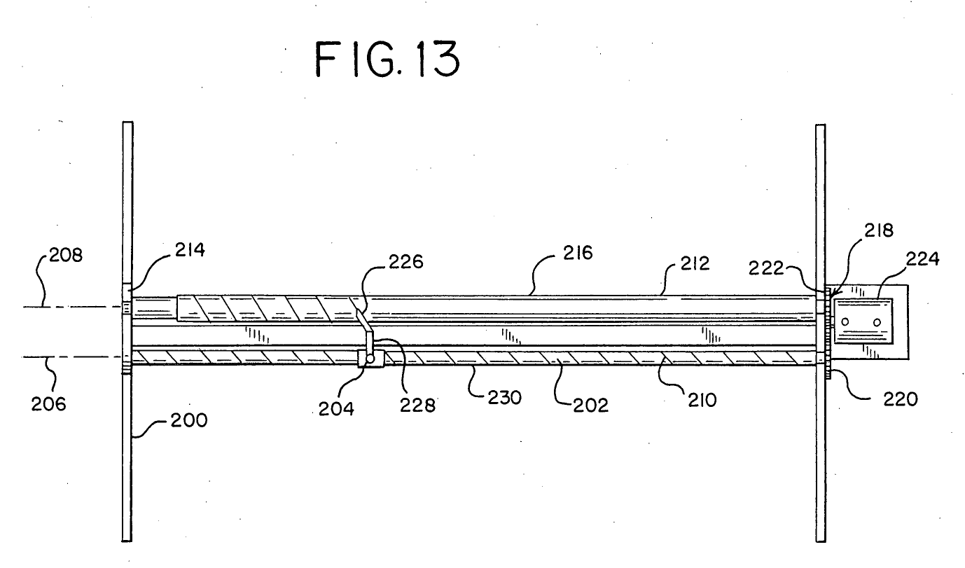

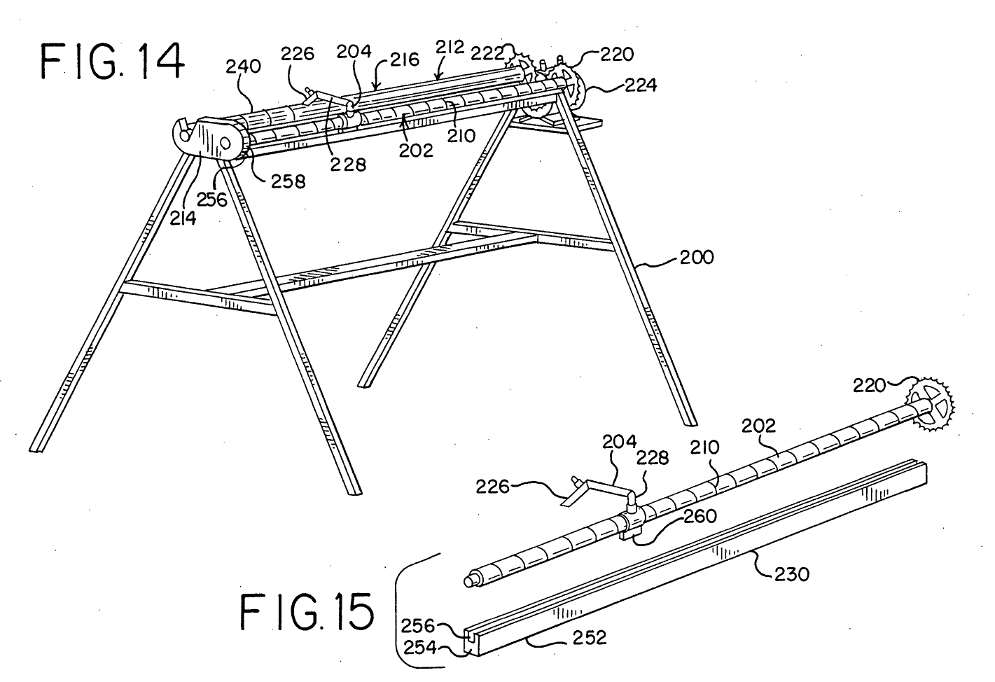

Referring to FIGS. 12-15, a slitting apparatus includes a support stand 200 and a drive shaft 202 rotatably mounted on the support stand about a first longitudinal axis 206. The drive shaft has a helical groove 210 formed in an outer surface thereof. A tube holder 212, shown as a support shaft, is rotatably supported by the stand, for example with a cradle 214 at one end, about a second longitudinal axis 209 spaced form the first longitudinal axis in a substantially parallel relationship. The tube holder can be configured in a number of different ways to secure a tube 216 thereon, for example by clamping or by friction, such that the tube rotates with the tube holder.

A drive gear assembly 218 is mounted on one end of the stand and includes a pair of driven gears 220, 222 coupled to the drive shaft and tube holder respectively. One or more drive gears mesh with the driven gears and rotate the driven gears and tube holder, preferably at the same rotational speed. A power source, such as a motor 224 (for example and without limitation) or hand crank turned by a user, is connected to the drive gear assembly to rotate the driven gears, and the drive shaft and tube holder.

A cutter 204 includes a slitting member 226 and a support structure 228. In one embodiment, the slitting member is configured as a fixed blade, such as an industrial utility knife blade or a heated style blade. Preferably, the blade is oriented at an oblique angle (i.e., neither parallel nor perpendicular) relative to the first and second longitudinal axis. A blade pressure bar 230 maintains engagement between the slitting member and the tube. The bar 230 includes a longitudinal slot or groove 252, which is engaged by a tongue 260 extending from the support structure. It should be understood that the bar could be configured with a ridge and the support member with a groove. The bar has one or more guide members 254 or pins that are disposed in a curved track 258 formed in an end plate member of the stand, shown as the cradle 214. A tightening or clamping member 256 is engaged with the stand to hold the bar in a particular desired orientation. In this way, the bar 230 can be rotated in the track 258 to apply more or less pressure on the tube 216 with the slitting member 226 while the tongue/groove engagement prevents the blade from rotating with the drive shaft 202. In other embodiments, the slitting member is a rotating blade, such as a rotary saw blade. The support structure is configured with a follower member, constructed for example as a pin that extends radially inward therefrom. The follower member disposed in and engages the groove 210 in the drive shaft.

In operation, the tube 216 is mounted on the tube holder 212. The power source 224 is actuated to drive the gear assembly 218 and rotate the drive shaft 202 and the tube holder 212 as the slitting member 226 engages the tube 216. As the drive shaft is rotated, the cutter 204 translates along the drive shaft 202 in a direction parallel to the longitudinal axis 206 as the follower is moved in the groove 210. In this way, the tube 216 is rotated relative to the cutter 204, and the cutter is translated relative to the tube 216, such that a helical cut 240 or slit is formed in the tube. In one embodiment, the spiral cut 240 formed in the tube has the same pitch as the spiral groove 210 on the drive shaft.

Referring to FIGS. 1 and 3, to install the cover, the strip 8 is wrapped around an elongated member 16, including for example and without limitation, posts, including for example and without limitation sign posts, mileage markers, fence posts, light posts, delineators, etc. The cover can be easily installed without the need for any tools. The elongated member can also be configured as guy wires or cables. It should be understood that the various embodiments of the cover shown as being installed on posts could also be installed on guy wires, with some modification of dimensions to accommodate the wire.

The strip 8 can be wrapped around any configuration elongated member or post, including for example and without limitations U-channel (shown in FIG. 3), square, and round shapes, the sizes of which (e.g., widths, diameters, diagonals) can be varied. As long as the post has at least one cross-sectional dimension greater than the inner diameter, or minimum cross-sectional dimension, of the cover, the inner surface of the strip will grip the outer surface of the post. Since the strip is preferably resilient and flexible, it can be expanded to fit around the various post configurations. It should be understood that while the preferred embodiment of the strip defines an interior cylindrical space (circular cross-sectional shape), the strip can be formed to define an interior rectangular or square cross-sectional shape, or any other polygonal shape.

While the strip 8 is resilient and flexible, it also has sufficient rigidity such that the strip maintains its helical configuration when in a freestanding configuration, which means the strip is not engaged with any post or other internal or external object. In this way, the strip maintains a substantially helical/cylindrical shape (or other preformed shape) even when not engaged with the post and when positioned in either a substantially vertical or horizontal orientation. This shape memory allows the strip to be easily applied to the post without the need for additional fasteners. Of course, the strip can be further secured to the post with fasteners, such as screws, adhesives, or with integrally formed tabs as explained below.

Once the strip 8 is applied to the post, or while it is being applied, the slit 14 or gap between adjacent edges 10, 12 of the strip can widened to extend the overall length of the cover 2, defined as the application length L of the cover, which is measured between the first and second ends of the cover. For example, as shown in FIG. 1, the width of the slit 14 can adjusted for example between at least a first and second width that corresponds to a first and second application length (L1 and L2) of the cover 2. In this way, the same cover can be used to provide cover or provide indicia for posts of different lengths, or for different desired lengths of coverage. Of course, it should be understood that the application length of a particular cover will also depend on the cross-sectional configuration/shape/size of the post. In this situation, the edges 10, 12 of the strip slide relative to each other as the interior of the cover is increased or decreased to accommodate different posts, which movement can alter the overall application length without the width of the slit being changed. In one embodiment, the cover has a minimum application length of about 33 inches when the slit width is approximately zero (0), and a maximum application length of about 52 inches, with the slit width of approximately 2 inches on a standard 4×4 post. In various embodiments, the initial application length (with the cover in a relaxed, non-expanded condition) is between about (and including) 1 foot to about 15 feet, with various lengths provided in one (1) foot increments.

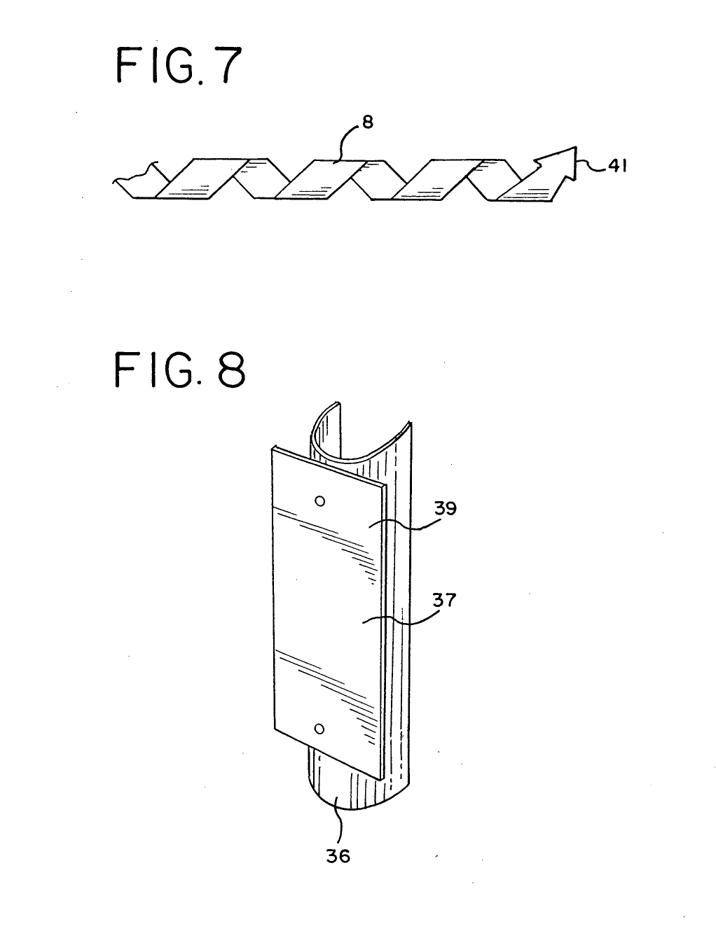

In one embodiment, shown in FIG. 7, a portion of the strip 8 forms a tab member 41 that is inserted through an opening formed in the post. In one embodiment, the tab member 41 is integrally formed from the same material as the strip, for example by cutting a portion of the strip to form a tab having a free end, although it should be understood that the tab member could be made as a separate component that is secured to the strip with fasteners, adhesive, and the like. The tab member 41 acts as a locator to prevent the strip from being moved or dislocated along a vertical direction or rotated about a longitudinal axis relative to the post 16. In other embodiments, the strip is secured to the post simply by gripping the post with the inner surface of the strip without any tab members or other fasteners. Alternatively, mechanical fasteners, adhesives, etc. can be used to secure the strip to the post. In one embodiment, the cover is provided with one or more openings to receive a fastener.

Referring to FIGS. 1, 2 and 4, a second embodiment of a cover 20 for use with an elongated member is shown. In this embodiment, the cover is formed as an elongated channel 22 having first and second ends 30, 32 and a longitudinal slit 24 defined by opposite side edges 26, 28 of the channel. The channel 22 can be formed from the same tubular blanks and/or materials as the first embodiment described above, but with a straight/linear slit 24 being made in a tube to form a channel rather than a helical slit 14 being made to form a spiral strip.

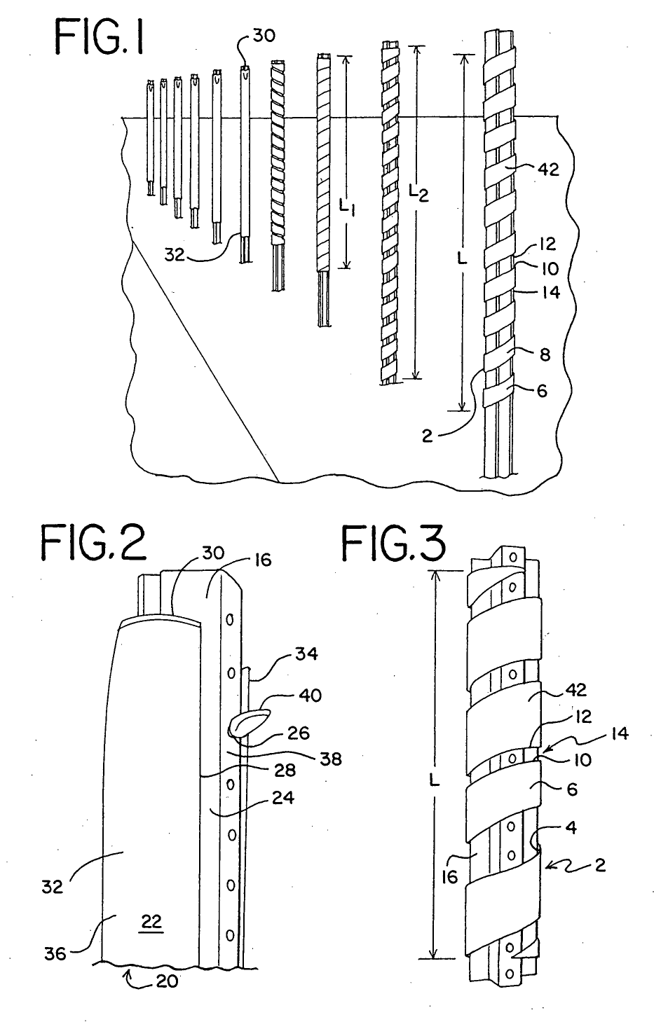

In this embodiment, the channel 22 fits around the post 16 by flexing the resilient material and enlarging the slit, for example by moving opposing edges defining the slit from an open position, wherein the channel can be fitted around the post, to a gripping position, by letting the channel spring or snap back and engage the post with the inner surface. The cover can be installed without the need for any tools. An inner surface 34 of the channel grips the post 16, regardless of its shape, configuration or size, while an outer surface faces a passerby. In one preferred embodiment, a portion of the channel forms a tab member 40 that is inserted through an opening 38 formed in the post, as shown for example in FIG. 2. Preferably the tab member 40 is integrally formed from the same material as the channel, for example by cutting a portion of the channel to form a tab having a free end, although it should be understood that the tab member could be made as a separate component that is secured to the channel with fasteners, adhesive, and the like. The tab member 40 acts as a locator to prevent the channel 22 from being moved or dislocated along a vertical direction or rotated about a longitudinal axis relative to the post 16. In other embodiments, the cover is secured to the post simply by gripping the post with the inner surface of the cover without any tab members or other fasteners. Alternatively, mechanical fasteners, adhesives, etc. can be used to secure the cover to the post. In one embodiment, the cover is provided with one or more openings to receive a fastener.

The overall length of the cover 20 can vary depending on the post to be covered. For example and without limitation, the cover can have a length of between about (and including) one foot to about 6 feet, with various lengths provided at six (6) inch to one-foot increments. The outer surface of the channel is preferably curved or rounded. However, the face of the channel that will be facing an oncoming passerby, such as a vehicle, can be flattened or widened so as to provide a greater surface area, covered for example with indicia as explained below, exposed to the passerby. In one embodiment, the channel extends around the post, and can provide indicia on all sides thereof, for example from 270° to 360°.

In an alternative embodiment, shown in FIG. 8, a secondary panel 37 is secured to an outer surface 36 of the channel, for example with adhesive or fasteners, and includes an outer surface 39.

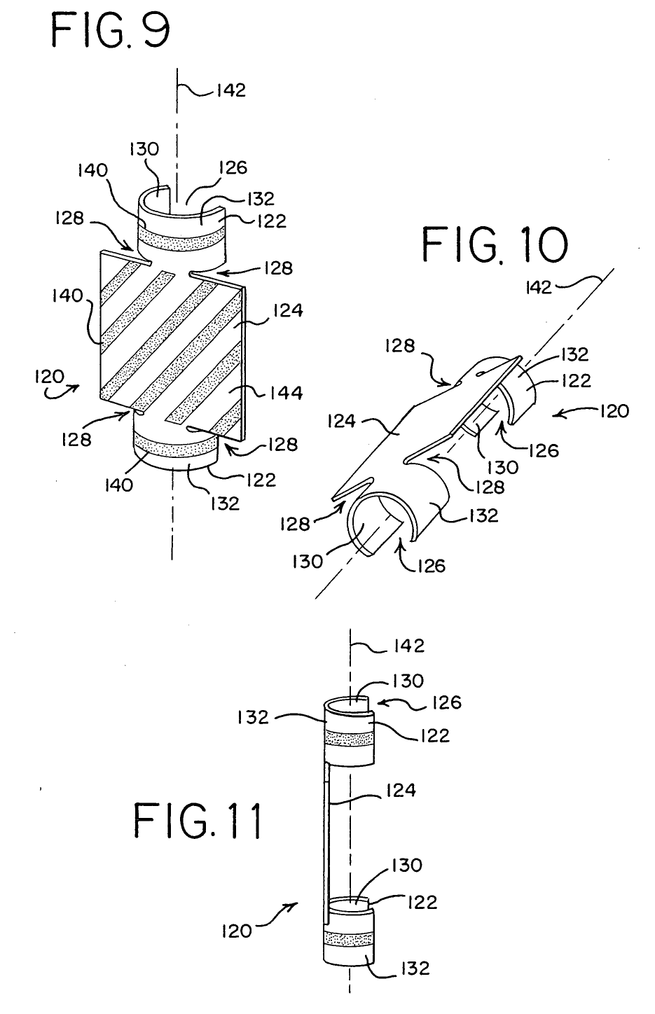

In yet another embodiment, shown in FIGS. 9-11, the cover 120 includes a pair of resilient channels, or collars 122, each having a longitudinal slit 126. A panel 124 is disposed between and connected to the collars, which are spaced apart along a longitudinal axis. Instructional indicia 140 (shown for example and without limitation as stripes) are applied to the outer surface of the panel, as well as the outer surface 132 of the spaced apart collar portions. The collars, and in particular an inner surface 130 thereof, grip the elongated post as described above. It should be understood that the cover could be configured with a single collar, with the panel extending from one end thereof, or with more than one panel. For example, in one embodiment (not shown), the cover includes three collars spaced apart and connected to a pair of panel members disposed between the collars.

The cover can be made by forming a longitudinal slit 126 in a tube, and then by making cross direction cuts 128 substantially non-parallel to a longitudinal axis 142, for example substantially perpendicular to the longitudinal axis (although other angles would also work). For example, the tube can be cut at a first and second cut along a cross direction approximately 80-90% of the tube depth, or around the diameter of the tube. The panel portion 124, which is initially curved, can then be substantially flattened, meaning that it may have some curvature, but less curvature than the tube from which it is cut. The panel portion 124 provides a face 144 for instructional indicia 140, while the collars, which can also include indicia 140, can also provide indicia around the entire post. In one embodiment, reflective sheeting is wrapped around the outer surface of the channel members or collars. It should be understood that the longitudinal slit can be made first, and then the cross-direction cuts, or vice versa the tube can be cut in the cross direction and the longitudinal slit then formed. The integral, one-piece cover, including the collars and panel, provides a simple, inexpensive, easy to install (no hardware) cover and sign with instructional indicia. Moreover, the panel is robust, flexible and resilient, meaning that it cannot be dented or bent, which thereby reduces maintenance and replacement costs. Moreover, when made from plastic, the material is corrosion resistant.

In any of the embodiments, shown in FIGS. 1, 4, 5 and 8-11, the outer surface 6, 36, 39 of the cover 2, 20 is provided with instructional indicia 42, 140 that provide advisory information to a passerby. The term “indicia” should be broadly interpreted to mean any visual property, e.g., reflective properties, color, markings, pattern, etc., that provides the passerby with some information, whether it be merely a reflection of light to indicate the location of a post, colors (reflective and non-reflective) that indicate the location of the post or provide other information, or additional symbols and/or alphanumeric characters that advise the passerby of specific information, including for example and without limitation mileage, directions, advisory actions, warnings, etc. As shown in FIGS. 5 and 9, the indicia can be configured as stripes, solid colors, etc., which may or may not be reflective. The indicia can extend across the entire width of the strip, or a lesser width (e.g., by forming a single central stripe, or two spaced apart stripes or other variations thereof).

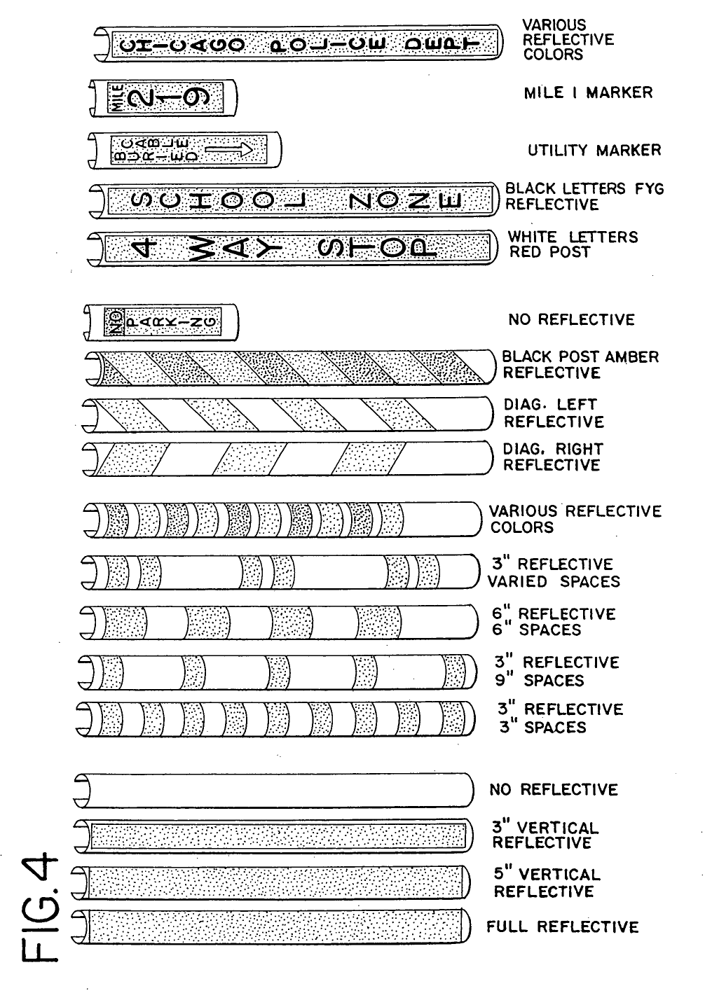

As shown in FIG. 4, the markings can be spaced at various vertical locations and can have various heights, the markings can surround the cover to various degrees, the markings can be formed as horizontal, diagonal or vertical stripes, and/or the markings can provide instructions information (e.g., stop, school zone, locations, mileages, etc.). For example, the reflective material can be formed in strips having a width of 3 inches, 5 inches or completely covering the outer surface of the channel, or any other width. Likewise, strips having a width of 3 inches, 6 inches or any other width can be disposed horizontally, or diagonally (oriented left or right) along the channel, and can be spaced various distances, e.g., 3 inches, 6 inches, 9 inches, or any other distance. Different strips on the same channel can be made of different colors or indicia. Of course, the markings can be configured as combinations of any of the various configurations disclosed herein. The indicia can include different markings and colors and combinations thereof. For example, the cover can be provided for example and without limitation in white, yellow, orange, green, red, blue, black, brown, or various combinations thereof. In any of the embodiments described herein, the covers can extend around the entirety of the post to provide indicia on all sides of the post, or the indicia can be applied to a less angular surface, e.g., 180 degrees. As shown in FIGS. 1, 3 and 6, the shape of the strip itself can provide the indicia, for example the strip intrinsically provides indicia of a hazard warning. The indicia can be in the form of reflective or non-reflective coatings and materials. It should be understood that any of the indicia can be applied to any of the embodiments of the cover.

The outer surface 6, 36, 132, 144 can be formed by a reflective sheeting, for example and without limitation, ASTM Types III (high intensity), V (regular and abrasion resistant), VII (Diamond Grade LDP (long distance performance) or fluorescent LDP)), and/or IX (Diamond Grade VIP (visual impact performance)), or combinations thereof. For example, various suitable reflective sheeting materials are available from 3M Traffic Safety Systems Division, St. Paul, Minn. The reflective coating can be applied by painting or by adhesive application of the reflective sheeting. The reflective material can be formed along only a vertical portion of the cover (e.g., 3 or 5 inches wide), or cover the entire outer surface.

Preferably, the reflective material or sheeting is applied to a plastic, such as the tube, that has been recently flame treated. Furthermore, the plastic tube preferably is flame treated and the reflective material is applied thereto prior to cutting the cover, for example by forming a longitudinal slit, a helical slit, and/or cross direction cuts. In one embodiment, the flame treating is performed in-line with the extrusion process that forms the plastic tube. The extruded tube passes through a flame ring at about 5 to 5.4 inches per second. In other embodiments, the exposure to the flame is about 1 second. The flame is fueled by natural gas. In one embodiment, the tip of the outer blue envelope of flame just touches the outer surface of the material being treated. In one embodiment, the air-to-gas ratio is between 11-12:1 for natural gas.

In one embodiment, the reflective material is applied on the same day as the flame treatment, and in other embodiments within three (3) days of the flame treating. In one embodiment, the tube is allowed to cool for at least 15 minutes prior to applying the reflective sheeting. If the allotted time has passed, the tube can be flame treated again prior to application of the reflective material.

In one procedure for applying the reflective sheeting, the minimum temperature is 60° F., with the plastic tube and reflective sheeting being allowed to reach the application temperature for at least four hours prior to application. The tube surface is cleaned prior to application (and flame treating if performed off-line or some time later after extrusion), for example with a isopropyl alcohol or 70% rubbing alcohol.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

1. A cover for use on a elongated member comprising:
a strip having a helical configuration, an inner surface and an outer surface, at least a portion of said outer surface comprising informational indicia, wherein said inner surface is adapted to grip the elongated member, and wherein said strip comprises sufficient rigidity such that said strip maintains said helical configuration when in a freestanding configuration.

2. The cover of claim 1 wherein said indicia comprises a reflective material.

3. The cover of claim 1 wherein said indicia comprises alphanumeric characters.

4. The cover of claim 1 wherein said indicia comprises symbols.

5. The cover of claim 1 wherein said strip comprises a plastic material.

6. The cover of claim 5 wherein said strip comprises a polyethylene material.

7. The cover of claim 5 wherein said strip comprises a urethane material.

8. The cover of claim 5 wherein said strip comprises an elastomeric material.

9. The cover of claim 1 wherein said strip defines an application length and wherein strip defines a slit formed between edges of said strip along said helical configuration, wherein said slit has a width, and wherein said width of at least a portion of said slit is adjustable between at least a first and second width such that said application length is adjustable between at least a first and second application length.

10. A method of installing a cover on an elongated member comprising:
providing a strip having a helical configuration, an inner surface and an outer surface, at least a portion of said outer surface comprising informational indicia, wherein said strip comprises sufficient rigidity such that said strip maintains said helical configuration when in a freestanding configuration; and
wrapping said strip around the elongated member with said inner surface gripping the elongated member.

11-16. (canceled)

17. A cover for use on an elongated member comprising:
a longitudinally extending, resilient channel having opposite first and second ends, an inner surface and an outer surface, at least a portion of said outer surface comprising informational indicia, wherein said inner surface is adapted to grip the elongated member, and wherein said channel comprises a tab portion adapted to engage the elongated member.

18. The cover of claim 17 wherein said indicia comprises a reflective material.

19. The cover of claim 17 wherein said indicia comprises alphanumeric characters.

20. The cover of claim 17 wherein said indicia comprises symbols.

21. The cover of claim 17 wherein said channel comprises a plastic material.

22. The cover of claim 17 further comprising a secondary panel connected to said channel and defining said outer surface.

23. A method for making a cover for use on a post comprising:
rotating a tube comprising a reflective surface about a longitudinal axis;
translating said tube or a cutter in a direction parallel to said longitudinal axis simultaneously with said rotating said tube; and
cutting said tube with said cutter simultaneously with said translating said tube or said cutter and simultaneously with said rotating said tube and thereby forming a helical slit in said tube.

24-32. (canceled)

33. A cover for use on an elongated member comprising:
a resilient channel having a longitudinal slit defining opposing edges moveable between an open position and a gripping position, said channel having a inner surface adapted to grip the elongated member; and
a panel connected to said channel.

34. The cover of claim 32 wherein said resilient channel comprises a pair of spaced apart collars, wherein said panel is disposed between and connected to said spaced apart collars, said panel comprising informational indicia.

35. The cover of claim 33 wherein said collars and said panel are integrally formed.

36-41. (canceled)
